(19) United States
(12) Patent Application Publication
(10) Pub. No.: US 2019/0112403 A1
(43) Pub. Date: Apr. 18, 2019

(54) PROCESS FOR PRODUCING FLUORORESIN

(71) Applicant: AGC Inc., Chiyoda-ku (JP)

(72) Inventors: Masatoshi ABE, Chiyoda-ku (JP); Takashi SATO, Chiyoda-ku (JP); Tomoya HOSODA, Chiyoda-ku (JP); Takuya NAKAO, Chiyoda-ku (JP)

(73) Assignee: AGC Inc., Chiyoda-ku (JP)

(21) Appl. No.: 16/200,996

(22) Filed: Nov. 27, 2018

Related U.S. Application Data
(63) Continuation of application No. PCT/JP2017/020126, filed on May 30, 2017.

(30) Foreign Application Priority Data
May 31, 2016 (JP) 2016-109094

(51) Int. Cl. C08F 214/26; C08J 5/18; H01B 13/14; H01B 3/44

(52) U.S. Cl. CPC C08F 214/265; C08J 5/18; H01B 13/14; H01B 3/445; B29K 2027/18; B29C 47/025; C08F 2800/10; C08J 2327/18; B29C 47/0014

(57) ABSTRACT

A process for producing a fluororesin in which a low-boiling component is reduced, by subjecting a melt-formable fluororesin to melt-kneading treatment by a twin screw extruder 10, wherein the twin screw extruder 10 has at least one melting zone, a set temperature of a most upstream first melting zone Z1 among melting zones is the melting point of the fluororesin +25 to 100° C., a vacuum degree at a vent port of the vacuum vent 14 is at most −0.07 MPa [gage], and a melt mass-flow rate α2 (g/10 min) of the fluororesin after the melt-kneading treatment at a specific temperature under a specific load, to a melt mass-flow rate α1 (g/10 min) of the fluororesin before the melt-kneading treatment at the same temperature under the same specific load satisfy α1<α2≤α1+14.

This application is a continuation of PCT Application No. PCT/JP2017/020126, filed on May 30, 2017, which is based upon and claims the benefit of priority from Japanese Patent Application No. 2016-109094 filed on May 31, 2016. The contents of those applications are incorporated herein by reference their entireties.

### FIELD OF INVENTION

The present invention relates to a process for producing a fluororesin having a low-boiling component.

### BACKGROUND OF INVENTION

Fluororesins, which are excellent in heat resistance, flame retardancy, chemical resistance, weather resistance, non-stickiness, low friction property, low dielectric property, etc. are widely used for various applications. In particular, a tetrafluoroethylene/hexafluoropropylene copolymer (hereinafter, referred to also as “FEP”) and an ethylene/tetrafluoroethylene copolymer (hereinafter, referred to also as “ETFE”) are melt-formable, and therefore their applications are various. For example, ETFE is used as a material for e.g. a film, a release film or a coating layer of an electric wire in film structures (such as a swimming pool, a gymnasium, a tennis court, a football ground, a warehouse, a hall, an exhibition hall, a horticultural greenhouse and an agricultural greenhouse).

Along with high integration and microsizing of an electronic component, a release film is required to have e.g. less contamination of an electronic component and less surface roughness on a release film, due to a low-boiling component contained in a fluororesin. Accordingly, a fluororesin is required to have less low-boiling component.

As a process for producing a fluororesin having less low-boiling component, for example, the following process has been proposed.

A process for producing a fluororesin by introducing a deaeration auxiliary agent such as nitrogen gas into a twin screw extruder and discharging a low-boiling component together with the deaeration auxiliary agent from a vacuum vent disposed on a barrel of the twin screw extruder, at the time of melt-kneading a fluororesin such as FEP by the twin screw extruder (Patent Document 1).

### PRIOR ART DOCUMENTS

### Patent Documents

Patent Document 1: JP-A-2009-095978

### SUMMARY OF INVENTION

### Technical Problem

However, in the process for producing a fluororesin, it is necessary to increase a set temperature of a melting zone in a twin screw extruder for sufficiently reducing a low-boiling component. Therefore, decomposition of a fluororesin tends to be accelerated at the time of melt-kneading the fluororesin, whereby there is a case where the low-boiling component cannot sufficiently be reduced. In particular, in the case of a fluororesin containing ETFE which is more easily decomposed than FEP, the low-boiling component tends to rather increase.

The present invention is to provide a process for producing a fluororesin by which it is possible to sufficiently reduce a low-boiling component contained in the fluororesin.

### Solution to Problem

The present invention has the following gist.
<1> A process for producing a fluororesin, the process comprising:

subjecting a melt-formable fluororesin to melt-kneading treatment by the following twin screw extruder under the following conditions to produce a fluororesin satisfying the following formula (I):

α1<α2≤α1+14 (I)

wherein α2 is a melt mass-flow rate (g/10 min) of the fluororesin after the treatment, and α1 is a melt mass-flow rate (g/10 min) of the fluororesin before the treatment (provided that the two melt mass-flow rates are measured under a load of 49 N at the same temperature higher by 20 to 40° C. than the melting point of the fluororesin),

twin screw extruder: a twin screw extruder comprising two screws each having a shaft and a plurality of screw elements mounted on the shaft, a barrel having the two screws incorporated therein, and a vacuum vent disposed on the barrel, and comprising at least one melting zone in which, among the screw elements, two or more of mixing elements are continuously disposed, and/or two or more of kneading elements are continuously disposed,

melt-kneading conditions: a temperature of the most upstream melting zone among melting zones in the twin screw extruder is higher by 25 to 100° C. than the melting point of the fluororesin to be treated, and a vacuum degree at a vent port of the vacuum vent in the twin screw extruder is at most −0.07 MPa [gage].
<2> The process according to <1>, wherein in the twin screw extruder, the number of melting zones is from 1 to 6, the vacuum vent is located downstream of the most upstream melting zone, and a total length L (mm) of the screw elements in the melting zone and an inner diameter D (mm) of the barrel satisfy the following formula (II):

L/D≥3 (II)
<3> The process according to <1> or <2>, wherein in the twin screw extruder, a shear rate γ obtained from the following formula (IV) is at least 1,000 sec⁻¹,

γ=π×(D−2h)×N/(60×h) (IV)

wherein γ is a shear rate (sec⁻¹), π is 3.14, D is an inner diameter (mm) of the barrel, N is a number of revolutions (rpm) of the screw, and h is a minimum chip clearance (mm) in the kneading element.
<4> The process according to any one of <1> to <3>, wherein the melt-kneading treatment is conducted to satisfy the following formula (III):

Q/(N×D³)<6.1×10⁻⁸ (III)

wherein Q is a discharge amount (kg/min) of the fluororesin from the twin screw extruder, N is a number of revolutions (rpm) of the screw, and D is an inner diameter (mm) of the barrel.
<5> The process according to any one of <1> to <4>, wherein the fluororesin to be subjected to the melt-kneading treatment is a fluororesin not being subjected to treatment including melting during a period between production of the fluororesin by polymerization of monomers and the melt-kneading treatment.
<6> The process according to any one of <1> to <5>, wherein the fluororesin is extruded into a strand from the twin screw extruder, and cut into a pelletized fluororesin subjected to the melt-kneading treatment.
<7> The process according to any one of <1> to <6>, wherein the fluororesin comprises a copolymer having units based on ethylene and units based on tetrafluoroethylene.
<8> The process according to <7>, wherein the copolymer is a copolymer in which a proportion of the units based on ethylene is from 44 to 50 mol %, relative to the total of the units based on ethylene and the units based on tetrafluoroethylene.
<9> The process according to <7> or <8>, wherein the copolymer further comprises units based on a third monomer (provided that the third monomer may be composed of two or more types of monomers) copolymerizable with ethylene and tetrafluoroethylene, and a proportion of the units based on the third monomer is from 0.7 to 2.4 mol %, relative to all units of the copolymer.
<10> The process according to any one of <7> to <9>, wherein the temperature in each of the measurements of the melt mass-flow rate α1 and the melt mass-flow rate α2 is 297° C.
<11> The process according to any one of <1> to <10>, wherein the fluororesin subjected to the melt-kneading treatment contains the following residue,

a temperature at which 1 mass % of the following residue decomposes, is at least 115° C.,

a temperature at which 5 mass % of the following residue decomposes, is at least 150° C., and

a temperature at which 10 mass % of the following residue decomposes, is at least 180° C.:

residue: a residue obtained by immersing the fluororesin subjected to melt-kneading treatment in 1,3-dichloro-1,1,2,2,3-pentafluoropropane at 150° C. for 12 hours, then removing a solid matter, and heating a liquid under reduced pressure.
<12> The process according to any one of <1> to <11>, wherein no deaeration auxiliary agent is introduced to the twin screw extruder when the fluororesin is subjected to melt-kneading treatment by the twin screw extruder.
<13> A process for producing a film, the process comprising:

obtaining a fluororesin by the process for producing a fluororesin as defined in any one of <1> to <12>; and

forming the fluororesin.
<14> A process for producing an electric wire, the process comprising:

obtaining a fluororesin by the process for producing a fluororesin as defined in any one of <1> to <12>; and

extruding the fluororesin around a core wire to form a coating layer.
<15> A fluororesin which is a melt-formable fluororesin, wherein

a temperature at which 1 mass % of the following residue decomposes, is at least 115° C.,

a temperature at which 5 mass % of the following residue decomposes, is at least 150° C., and

a temperature at which 10 mass % of the following residue decomposes, is at least 180° C.:

residue: a residue obtained by immersing the fluororesin in 1,3-dichloro-1,1,2,2,3-pentafluoropropane at 150° C. for 12 hours, then removing a solid matter, and heating a liquid under reduced pressure.

### Advantageous Effects of Invention

According to the process for producing a fluororesin of the present invention, it is possible to sufficiently reduce a low-boiling component contained in the fluororesin.

According to the process for producing a film of the present invention, it is possible to produce a film having less low-boiling component.

According to the process for producing an electric wire of the present invention, it is possible to produce an electric wire having less low-boiling component in a coating layer.

The fluororesin of the present invention contains less low-boiling component.

### BRIEF DESCRIPTION OF DRAWINGS

FIG. 1 is a schematic construction view illustrating one embodiment of a twin screw extruder used in Examples.

### DETAILED DESCRIPTION OF INVENTION

In this specification, the meanings of the following terms are as follows.

A “melting point” of a resin means a temperature corresponding to the maximum value of the melting peak measured by a differential scanning calorimetry (DSC) method.

The “melt-formable” means that melt-flowability is shown. “Melt-flowability is shown” means that a temperature at which the melt mass-flow rate is from 0.1 to 1,000 g/10 min is present at a temperature higher by at least 20° C. than the melting point of the resin under a load of 49N.

The “melt mass-flow rate” means a melt mass flow rate (MFR) as defined in JIS K7210: 1999 (ISO1133: 1997).

A “unit” in a polymer means an atomic group derived from one molecule of a monomer, formed by polymerizing the monomer. The unit may be an atomic group formed directly by a polymerization reaction, or an atomic group having a part of the above atomic group converted to another structure by treating the polymer.

A “fluoromonomer” means a monomer having fluorine atom(s) in its molecule.

A “non-fluoromonomer” means a monomer other than the fluoromonomer.

A “melting zone” in a twin screw extruder means a screw zone in which, among the screw elements, two or more of mixing elements are continuously disposed, and/or two or more of kneading elements are continuously disposed.

### <Fluororesin>

In the present invention, a fluororesin is made of a fluorinated polymer, and contains, as impurities, a small amount of components other than the fluorinated polymer. Here, the impurities include a low polymerization degree fluorinated polymer formed as a by-product in production of the fluorinated polymer, and a low polymerization degree fluorinated polymer formed by depolymerization after the polymerization. Further, a fluororesin before treatment may contain a small amount of additives added at the time of polymerization or after the polymerization. Further, the fluororesin in the present invention is a melt-formable fluororesin from the viewpoint of excellent formability.

The fluororesin to be subjected to melt-kneading treatment in the present invention contains at least a fluorinated polymer and, as impurities, a small amount of after-mentioned low-boiling component, and the content of the low-boiling component is reduced by the melt-kneading treatment of the present invention. The fluororesin to be subjected to the melt-kneading treatment may be a fluororesin produced by polymerization of monomers and taken out from a polymerization system, or a fluororesin purified by a subsequent optional purification method. The fluororesin to be subjected to the melt-kneading treatment in the present invention is preferably a fluororesin not being subjected to treatment including melting during a period between the production of the fluororesin by polymerization of monomers and the melt-kneading treatment.

Further, a fluororesin before melt-kneading treatment in the present invention will be hereinafter, referred to also as “fluororesin A”. Further, a fluororesin obtained from the fluororesin A and subjected to the melt-kneading treatment in the present invention will be hereinafter, referred to also as “fluororesin B”.

The amount of a low-boiling component contained in the fluororesin B can be estimated from a decomposition temperature of a soluble content to a fluorinated solvent. That is, by an increase of a temperature at which a predetermined amount of the following residue decomposes, a decrease of the low-boiling component in the fluororesin B from the fluororesin A can be confirmed. Further, an increase of a decomposition temperature of the low-boiling component means that a low heat-resistance and high volatile component reduces in the low-boiling component.

It is said that the low-boiling component contained in the fluororesin A is sufficiently reduced in a case where a temperature at which 1 mass % of the following residue obtained from the fluororesin B decomposes is at least 115° C., a temperature at which 5 mass % of the following residue decomposes is at least 150° C., and a temperature at which 10 mass % of the following residue decomposes is at least 180° C.

Residue: a residue obtained by immersing the fluororesin in 1,3-dichloro-1,1,2,2,3-pentafluoropropane at 150° C. for 12 hours, then removing a solid matter, and heating a liquid under reduced pressure.

The temperature at which a predetermined amount of the residue decomposes, is measured by the method in the after-mentioned Examples.

The fluororesin may be a fluorinated polymer having units based on at least one fluorinated monomer selected from tetrafluoroethylene (hereinafter, referred to also as “TFE”), hexafluoropropylene (hereinafter, referred to also as “HFP”), a perfluoro(alkyl vinyl ether), chlorotrifuoroethylene (hereinafter, referred to also as “CTFE”), vinylidene fluoride (hereinafter, referred to also as “VdF”) and vinyl fluoride. Such a polymer may be a homopolymer or a copolymer.

The fluorinated polymer may further have units based on a non-fluorinated monomer. The non-fluorinated monomer may, for example, be ethylene, propylene, itaconic anhydride or vinyl acetate. In a case where the fluorinated polymer has units based on the non-fluorinated monomer, the units based on the non-fluorinated monomer may be only one type or at least two types.

The melt-formable fluororesin may, for example, be a fluororesin made of a fluorinated polymer such as ETFE, a TFE/perfluoroalkyl vinyl ether copolymer (PFA), a TFE/perfluoroalkyl vinyl ether/HFP copolymer (EPA), FEP, polychlorotrifuoroethylene (PCTFE), a CTFE/ethylene copolymer (ECTFE) or polyvinylidene fluoride (PVdF).

A fluororesin to be used is one having a melting point from the viewpoint that the fluororesin is melt-kneaded by a twin screw extruder. The melting point of the fluororesin is preferably from 160 to 325° C., more preferably from 220 to 320° C., furthermore preferably from 250 to 270° C. When the melting point of the fluororesin is at least the lower limit value of the above range, a formed product containing the fluororesin is excellent in heat resistance and excellent in rigidity at a high temperature. When the melting point of the fluororesin is at most the upper limit value of the above range, the fluororesin is excellent in formability.

The fluororesin is preferably a fluororesin made of ETFE, from the viewpoint of excellent formability.

ETFE is a copolymer having units based on ethylene and units based on TFE.

ETFE is preferably a copolymer having units (hereinafter, referred to also as “units (a1)”) based on ethylene, units (hereinafter, referred to also as “units (a2)”) based on ETFE and units (hereinafter, referred to also as units (a3)”) based on a third monomer copolymerizable with ethylene and ETFE, other than ethylene and ETFE, from the viewpoint that a formed product containing ETFE is more excellent in heat resistance, mechanical properties and chemical resistance. Here, the third monomer may be composed of at least two types of monomers, and in such a case, the at least two types of monomers are generally referred to as the third monomer, and the amount of the third monomer or the amount of units based on the third monomer are the total amount of e.g. the at least two types of monomers.

The third monomer may, for example, be a compound (hereinafter, referred to also as “FAE”) represented by the following formula (V):

CH₂═CX(CF₂)ₙY (V)

wherein X and Y are each independently a hydrogen atom or a fluorine atom, and n is an integer of from 1 to 10.

The third monomer is preferably FAE since a formed product containing ETFE is more excellent in mechanical properties and thermal stability.

X in the formula (V) is preferably a hydrogen atom from the viewpoint that a formed product containing ETFE is more excellent in flexibility, elongation and strength.

Y in the formula (V) is preferably a fluorine atom from the viewpoint that a formed product containing ETFE is more excellent in heat resistance and chemical resistance.

n in the formula (V) is preferably from 2 to 8, more preferably from 2 to 6, furthermore preferably 2, 4 or 6. When n is at least the lower limit value of the above range, a formed product containing ETFE is more excellent in mechanical properties and thermal stability. When n is at most the upper limit value of the above range, FAE has sufficient polymerization reactivity.

As a preferred specific example of FAE, CH₂═CH(CF₂)₂F, CH₂═CH(CF₂)₄ F, CH₂═CH(CF₂)₆ F, CH₂═CF(CF₂)₄ F or CH₂═CF(CF₂)₃ H may, for example, be mentioned, and from the viewpoint that a formed product containing ETFE is more excellent in mechanical properties and thermal stability, CH₂═CH(CF₂)₄ F (hereinafter, referred to also as “PFBE”) is preferred.

As FAE, one type may be used alone, or at least two types may be used in combination.

The molar ratio ((a1)/(a2)) of the units (a1) to the units (a2) is from 44/56 to 50/50, preferably from 44.5/55.5 to 46/54. When (a1)/(a2) is at least the lower limit value of the above range, the melting point of ETFE is sufficiently high, and a formed product containing ETFE is excellent in heat resistance and rigidity at a high temperature. When (a1)/(a2) is at most the upper limit value of the above range, a formed product containing ETFE is excellent in chemical resistance.

The proportion of the units (a3) is preferably from 0.7 to 2.4 mol %, more preferably from 0.9 to 2.2 mol % relative to all units constituting ETFE. When the proportion of the units (a3) is at least the lower limit value of the above range, a formed product of ETFE is excellent in stress crack resistance at a high temperature. When the proportion of the units (a3) is at most the upper limit value of the above range, the melting point of ETFE is sufficiently high, and a formed product containing ETFE is excellent in heat resistance and excellent in rigidity at a high temperature.

ETFE may have a chlorine atom or may not have a chlorine atom at a terminal of the main chain. ETFE is preferably one having no chlorine atom at a terminal of the main chain from the viewpoint of heat resistance.

ETFE having no chlorine atom at a terminal of the main chain may, for example, be obtained using, as a chain transfer agent, an alcohol, a hydrocarbon or a hydrofluorocarbon, during polymerization of monomers. Specifically, as described in the paragraph [0016] of JP-A-2016-043566, in a case where an alcohol is used as a chain transfer agent, a hydroxy group of the alcohol is introduced to the main chain terminal of ETFE, and ETFE thus has a terminal group of a hydroxy group at the main chain terminal. The main chain terminal of ETFE can be confirmed by analyzing ETFE by means of infrared absorption spectrometry.

The melting point of ETFE is preferably from 160 to 320° C., more preferably from 245 to 270° C., furthermore preferably from 250 to 265° C. When the melting point of ETFE is at least the lower limit value of the above range, a formed product containing ETFE is excellent in heat resistance and excellent in rigidity at a high temperature. When the melting point of ETFE is at most the upper limit value of the above range, the fluororesin is excellent in formability.

The melting point of ETFE can be controlled by e.g. a method of adjusting e.g. the molar ratio ((a1)/(a2)) of the units (a1) to the units (a2) or the proportion of the units (a3) in all units constituting ETFE.

ETFE can be produced by e.g. a method described in the paragraphs [0021] to [0025] of WO2013/015202, or a method described in the paragraphs [0036] to [0043] of WO2016/006644.

The melt mass-flow rate of ETFE at 297° C. under a load of 49N is preferably from 1 to 100 g/10 min, more preferably from 4 to 42 g/10 min. When the melt mass-flow rate of ETFE is at least the lower limit value of the above range, ETFE is excellent in formability. When the melt volume-flow rate of ETFE is at most the upper limit value of the above range, a formed product containing ETFE is excellent in mechanical properties and excellent in stress crack resistance at a high temperature.

Here, a melt volume-flow rate of the fluororesin is an index of the molecular weight of the fluorinated polymer, and can be controlled by e.g. a method of adjusting the amount of a chain transfer agent at the time of producing the fluorinated polymer. Further, it can be also controlled by using two or more of the same type of fluorinated polymers but having different melt volume-flow rate in combination.

The low-boiling component contained in the fluororesin A is a component which volatilizes at a temperature of melt-forming the fluororesin.

The low-boiling component contained in the fluororesin A may, for example, be an unreacted monomer, a low-molecular weight fluorinated polymer or a polymerization solvent.

In a case where the fluororesin A contains impurities derived from a component used for purification after polymerization or an additive added before conducting the treatment in the present invention, the fluororesin A may contain such an additive or a sub component contained in the additive. Among them, the content of the low-boiling component (such as a solvent) is reduced by the treatment in the present invention.

The fluororesin A may contain a small amount of an additive by which the physical properties of the fluororesin is less changed at the time of melt-kneading treatment. It is preferred that the additive itself produces no low-boiling component at the time of the melt-kneading treatment. As a specific example, a non-melting stabilizer (such as copper oxide) capable of suppressing e.g. decomposition of the fluororesin at the time of melt-kneading treatment, may be mentioned.

In a case where the fluororesin A contains the additive, the content of the additive is preferably at most 5 parts by mass, more preferably at most 2 parts by mass, per 100 parts by mass of the fluorinated polymer.

### <Twin Screw Extruder>

The twin screw extruder of the present invention has two screws, a barrel having the two screws incorporated therein, a vacuum vent disposed on the barrel, a raw material supply port disposed on the barrel and a die disposed on the downstream end of the barrel.

The twin screw extruder of the present invention may be a co-rotating twin screw extruder co-rotating the two screws in a cylinder of the barrel having a figure-of-eight through hole, or a counter-rotating extruder counter-rotating the two screws. The twin screw extruder is preferably a co-rotating twin screw extruder from the viewpoint that transportation capacity, melt-kneading capacity and separation (dehydration) capacity are excellent, and efficiency of treating process is excellent since a resin can be continuously treated.

Intermeshing of the two screws may be non-intermeshing type, partially intermeshing type or completely intermeshing type. In order to reduce the low-boiling component contained in the fluororesin, it is preferred to increase the kneading degree by screws and increase the volatile effect of the low-boiling component, and therefore completely intermeshing type is preferred.

The screw to be used is necessarily such that the after-mentioned melting zone can be incorporated at an optional position of the screw. Therefore, a screw to be used is such that a plurality of screw elements are mounted on a shaft.

Such screw elements have the same cross sectional shape in a direction perpendicular to an axis. The screw element has an intrinsic function depending on the article number which means the number of flights, and a twist angle obtained by rotation of the cross sectional shape in the direction perpendicular to an axis around the shaft. As the screw elements, a rotary element, a kneading element and a mixing element are mentioned according to the function.

The rotary element, which has a twist angle obtain by continuous rotation around the shaft, is a screw element having a transportation capacity.

The kneading element is a screw element constituted by a plurality of plate disks having no twist angle.

The mixing element is a screw element in which notch is formed on a full flight element of forward threads, or a screw element in which a notch is formed on a full flight element of reverse threads. The mixing element may have self-cleaning properties or may not have self-cleaning properties.

The screws to be used for the twin screw extruder in the present invention are suitably constituted by the rotary element, the kneading element and the mixing element.

The twin screw extruder of the present invention has at least one melting zone in which, among the screw elements, two or more of mixing elements are continuously disposed, and/or two or more of kneading elements are continuously disposed. Since the twin screw extruder has the mixing zone, a fluororesin is melted, whereby the surface area of the fluororesin increases and the surface renewal effect of the fluororesin is kept for a long time. Therefore it is possible to enhance the effect of reducing the low-boiling component contained in the fluororesin.

Further, since the twin screw extruder thus has the melting zone, the two or more of mixing elements continuously disposed, and/or the two or more of kneading elements continuously disposed, allow the retention time of the fluororesin in the twin screw extruder to be prolonged. Further, upon passing through the first melting zone having the after-mentioned set temperature, the fluororesin is heated and melted by shearing heat of the screws, whereby the bonding property between the fluororesin and the screw improves, and occurrence of vent-up is suppressed. On the other hand, when the twin screw extruder has no melting zone, the fluororesin becomes in a non-molten state or a semi-molten state, whereby the bonding property between the fluororesin and the screw deteriorates, and the vent-up tends to easily occur.

The number of melting zones is preferably from 1 to 6, more preferably from 2 to 4. When the number of melting zones is at least the lower limit value of the above range, a low-boiling component contained in the fluororesin sufficiently volatilizes, and the low-boiling component can be sufficiently reduced. When the number of melting zones is at most the upper limit value of the above range, it is possible to suppress shearing heat generation or deformation and compression action to the fluororesin by the screw, whereby it is possible to suppress over-decomposition of the fluororesin. Accordingly, it is possible to further sufficiently reduce the low-boiling component contained in the fluororesin.

It is preferred that a total length L (mm) of the screw elements in the melting zone and an inner diameter D (mm) of the barrel satisfy the following formula (II).

L/D≥3 (II)

L/D is preferably from 3 to 25, more preferably from 6 to 20. When L/D is at least the lower limit value of the above range, the internal heat generation of the fluororesin by shearing heat generation or deformation and compression by the screws effectively works. When L/D is at most the upper limit value of the above range, the internal heat generation by excess shearing heat generation and deformation and compression to the fluororesin by the screw is suppressed.

The barrel is one having a plurality of barrel blocks connected in series.

The barrel blocks have a through hole corresponding to a cross-sectional shape of the screw.

The vacuum vent is disposed for the purpose of removing the low-boiling component contained in the fluororesin when the fluororesin is melt-kneaded by the screw of the twin screw extruder.

The vacuum vent can be disposed, for example, in the twin screw extruder using a barrel block provided with the vacuum vent. The vacuum vent may be disposed on some of barrel blocks.

It is preferred that the vacuum vent is disposed downstream (an injection side of the fluororesin) of the first melting zone as the most upstream melting zone among the melting zones. When the vacuum vent is disposed downstream of the first melting zone, it is possible to efficiently remove the low-boiling component contained in the fluororesin.

In a case where a plurality of melting zones are present, the vacuum vent may be disposed between the melting zones or downstream of all of the melting zones. It is more preferred that the vacuum vent is located downstream of all of the melting zones, since it is possible to efficiently remove the low-boiling component contained in the fluororesin.

When the twin screw extruder has only one raw material supply port, the raw material supply port is located upstream of the first melting zone.

When a plurality of raw material supply ports are present, the first raw material supply port located most upstream among the raw material supply ports, is located upstream of the first melting zone, and the other raw material supply ports may be located downstream of the first melting zone. The fluororesin is preferably supplied from the first raw material supply port, and other components may be supplied from the second and subsequent raw material supply ports.

In a case where the fluororesin is formed into pellets, a die is preferably such that the fluororesin can be extruded and formed into a strand.

The number of discharge ports in the die may be one or plural. The die is preferably one having a few to a few tens discharge ports since a plurality of strands are formed and the productivity is good.

### <Process for Producing a Fluororesin>

The process for producing a fluororesin of the present invention is a process for obtaining the fluororesin B having a lower low-boiling component than the fluororesin A, by melt-kneading the fluororesin A containing the fluororesin by a twin screw extruder.

The fluororesin A injected from the raw material supply port of the twin screw extruder is melt-kneaded in the twin screw extruder having a melting zone, and a low-boiling component volatilized from the fluororesin A is discharged outside of the twin screw extruder from the vacuum vent.

A set temperature of the first melting zone located most upstream among the melting zones, is the melting point of the fluororesin +25° C. or higher, preferably the melting point +50° C. or higher, more preferably the melting point +60° C. or higher. Further, the set temperature of the first melting zone is the melting point of the fluororesin +100° C. or lower, preferably the melting point +60° C. or lower, more preferably the melting point +40° C. or lower. When the set temperature of the first melting zone is at least the lower limit value of the above range, melting of the fluororesin A is accelerated, and over-decomposition due to cleavage of a molecular chain of the polymer by the screw is suppressed. When the set temperature of the first melting zone is at most the upper limit value of the above range, oxidative destruction of the fluororesin due to heat is suppressed.

The vacuum degree at a vent port of the vacuum vent is at most −0.07 MPa [gage], preferably at most −0.08 MPa [gage], more preferably at most −0.09 MPa [gage]. When the vacuum degree is at most the upper limit value of the above range, the effect of volatilizing a low-boiling component becomes excellent. The lower limit value of the vacuum degree at the vent port of the vacuum vent is not particularly limited, in a case where a retention time of the fluororesin in the extruder is short, the vacuum degree is preferably −0.099 MPa [gage] since it is necessary to maintain the effect of volatilizing a low-boiling component at a high level.

In the present invention, the following formula (1) is satisfied:

α1<α2≤α1+14 (I)

wherein α2 is a melt volume-flow rate (g/10 min) of the fluororesin B at the flowing temperature and under the following load, and al is a melt volume-flow rate (g/10 min) of the fluororesin A at the same temperature and under the same load as in α2.

Temperature: a specific temperature which is higher by 20 to 40° C. than the melting point of the fluororesin.

Load: 49N

The value of the difference between α1 and α2 (hereinafter, the difference will be referred to as “α2−α1”) at a melting point +20° C., and the value of α2−α1 at a melting point +40° C. are almost the same, and therefore, in the present invention, a measurement temperature of the melt volume-flow rate can be arbitrarily selected from the range of the melting point +20 to 40° C.

In a case where the fluororesin is e.g. ETFE, α1 and α2 are preferably a value at a temperature of 297° C. and a load of 49N.

The difference α2−α1 is more than 0 to 14, preferably from 1.3 to 10, more preferably from 1.3 to 7, furthermore preferably from 4 to 7. When α2−α1 is within the above range, the effect of reducing the low-boiling component contained in the fluororesin is high, for the following reasons. However, in order to achieve a sufficient effect of reducing the low-boiling component, a fluororesin is needed to be not only one satisfying the above formula (I) but also one produced by the production process using the above twin screw extruder and satisfying the above melt-kneading conditions.

Usually, when α2−α1 becomes large, this means that cleavage of a molecular chain of the polymer proceeds, before and after the melt kneading of the fluororesin A. If α2−α1 is less than the lower limit value of the above range, this means that the kneading degree of the fluororesin A obtained by the screw at the time of melt-kneading the fluororesin A is small, and the shearing heat generation by the screw and the renewal effect shown by the screw are small, whereby the effect of reducing the low-boiling component contained in the fluororesin A would be insufficient. On the other hand, if α2−α1 exceeds the upper limit value of the above range, the kneading degree of the fluororesin A by the screw is too large, and shearing heat generation thus is large, whereby cleavage of a molecular chain of the polymer accelerates. Accordingly, the effect of reducing the low-boiling component deteriorates.

In the present invention, it is preferred that the melt-kneading treatment is conducted to satisfy the following formula (III):

Q/(N×D³)<6.1×10⁻⁸ (III)

wherein Q is a discharge amount (kg/min) of the fluororesin B from the twin screw extruder, N is a number of revolutions (rpm) of the screw, and D is an inner diameter (mm) of the barrel.

Q/(N×D³) is preferably from 1.0×10⁻⁸ to 5.1×10⁻⁸, more preferably from 3.8×10⁻⁸ to 5.1×10⁻⁸. When the melt-kneading treatment is conducted so that Q/(N×D³) would be within the above range, removal of the low-boiling component is accelerated by the shearing heat generation and the surface renewal effect of fluororesin A due to screw rotation. On the other hand, if Q/(N×D³) is less than the lower limit value of the above range, a kneading degree of the fluororesin A by the screw is high, and the shearing heat generation thus is high, whereby heat decomposition of the fluororesin accelerates. If Q/(N×D³) exceeds the upper limit value of the above range, the kneading degree of the fluororesin A by the screw reduces, and the shearing heat generation and the surface renewal effect by the screw cannot be sufficiently obtained, whereby the removal of the low-boiling component would be insufficient.

In the present invention, the shear rate y obtained from the following formula (IV) is preferably at least 1,000 sec⁻¹, more preferably at least 1,000 sec⁻¹ and less than 5,000 sec⁻¹, furthermore preferably at least 1,500 sec⁻¹ and less than 3,000 sec⁻¹.

γ=π×(D−2h)×N/(60×h) (IV)

wherein γ is a shear rate (sec⁻¹), π is 3.14, D is an inner diameter (mm) of the barrel, N is a number of revolutions (rpm) of the screw, and h is a minimum chip clearance (mm) in the kneading element.

When the shear rate γ is at least the lower limit value of the above range, the surface renewal effect of the fluororesin A by screw shearing increases, whereby the effect of removing the low-boiling component is more excellent. When the shear rate γ is less than the upper limit value of the above range, the shearing heat generation due to shearing by the screw is reduced, and therefore heat decomposition of the fluororesin is suppressed.

The number of revolutions N of the screw is preferably from 200 to 450 rpm, more preferably from 250 to 400 rpm. When the number of revolutions N of the screw is within the above range, the number of surface renewals of the fluororesin A increases while decomposition of the fluororesin due to screw shearing is suppressed, and therefore the effect of volatilizing the low-boiling component increases.

The fluororesin B is discharged from the above twin screw extruder and is usually formed into a suitable shape. The shape of the fluororesin formed may, for example, be pellets, granules or a powder. In particular, preferred shape is pellets which are commonly used as raw materials for forming. For example, the fluororesin B in a molten state is extruded into a strand from a die mounted on the discharge port of the twin screw extruder, and then cut by a pelletizer to obtain pellets.

Now, the production of pellets of the fluororesin B will be explained.

Conditions for extruding the fluororesin B in a molten state are not particularly limited, and conventional conditions may suitably be applied.

A diameter of the strand is preferably from 1 to 10 mm, more preferably from 1 to 6 mm, furthermore preferably from 2 to 5 mm. When the diameter of the strand is at least the lower limit value of the above range, the strand is not too thin, and the strand is less likely to break before the strand is cut by a pelletizer. When the diameter of the strand is at most the upper limit value of the above range, the strand is not too thick, cooling time is short, and pellets having a desired quality and shape can be easily obtained. If the shape of the pellets is ununiform, there is a tendency that the pellets cannot stably be supplied in a forming machine at the time of forming the pellets.

The temperature of the strand immediately after discharged from the die is preferably a melting point of the fluororesin + at least 10° C. and less than 150° C., more preferably the melting point +20 to 130° C., furthermore preferably the melting point +30 to 100° C. When the temperature of the strand is at least the lower limit value of the above range, a melt fracture formed from the discharge port of the die is reduced, whereby the stability of the strand increases. When the temperature of the strand is at most the upper limit value of the above range, it is possible to suppress decomposition of the fluororesin.

The strand transportation means is not particularly limited so long as it is possible to carry out transportation of the strand. The transportation means may, for example, be a belt conveyer, a mesh conveyer, a net conveyer or drawing by a pelletizer.

It is preferred that the strand is subjected to cooling. The cooling of the strand may be air cooling or water cooling. The air cooling may, for example, be a method using e.g. a fun or a method of standing the strand to cool at the time of transporting it by the transportation means. The water cooling may, for example, be a method of immersing the strand to a cooling solution such as water filled in a container or a method of spraying a cooling solution to the strand.

The temperature of the strand after cooling (that is, a temperature of the strand at the time of cutting) is preferably from 35 to 200° C., more preferably from 50 to 150° C., furthermore preferably from 70 to 120° C. When the temperature of the strand after cooling is at least the lower limit value of the above range, the elastic modulus of the strand is not too high, and a load exerted to the pelletizer is small, whereby it is possible to suppress an equipment failure such as damage to bearing of a strand cutter. When the temperature of the strand after cooling is at most the upper limit value of the above range, the elastic modulus of the strand becomes not too low, whereby cutting property of the strand by a pelletizer is good.

A pelletizer is to cut a strand so as to prepare pellets. A pelletizer is usually provided with a strand cutter, and a strand cooled is cut by the strand cutter to prepare pellets.

The strand cutter is provided with e.g. a fixed blade and a rolling blade. A strand is sandwiched between the fixed blade and the rolling blade so as to be cut into a predetermined length, whereby pellets are obtained.

The rolling blade to be suitably used usually has a length in the central axis direction being from 80 to 550 mm and a diameter being from 160 to 360 mm.

The number of blades provided with the rolling blade are not particularly limited so long as it is plural.

The material of the blades provided with the rolling blade may, for example, be a WC—Co type alloy, a TiN—Ni type alloy, a TiC—Ni type alloy or an alloy having Fe as a main component.

A circumferential speed of the rolling blade is preferably from 10 to 30 m/sec, more preferably from 12 to 25 m/sec, furthermore preferably from 13 to 20 m/sec.

### <Use of Fluororesin B>

The fluororesin B obtained by the production process of the present invention is suitably used as a material to be formed, such as a film, a coating layer of an electric wire or other formed product, from the viewpoint of less generation amount of gas during forming and less contamination of a formed product due to the gas.

Into the fluororesin B, various additives may be blended at the time of the forming, so as to develop various characteristics depending on purposes.

The additives may, for example, be a metal oxide (such as copper oxide, zinc oxide, iron oxide, nickel oxide or cobalt oxide), a pigment/dye, a slidability imparting agent, an electroconductivity imparting material, a fiber reinforcing agent, a heat conductivity imparting agent, a filler, a resin other than a fluororesin, a modifier, a crystal nucleus agent, a foaming agent, a foaming nucleus agent, a crosslinking agent, an antioxidant, a photostabilizer and an UV absorber.

As the additive, one type may be used alone or at least two types may be used in combination. The content of the additive is properly set depending on the characteristics to be imparted to a formed product.

Among the additives, a particulate non-melting additive (such as a metal oxide, a pigment/dye, a slidability imparting agent, an electroconductivity imparting material, a fiber reinforcing agent, a heat conductivity imparting agent or a filler), has an average particle size of preferably from 0.1 to 30 μm, more preferably from 0.5 to 10 μm. The particulate additive has a BET specific surface area of preferably from 5 to 60 m²/g, more preferably from 10 to 30 m²/g. When the particulate additive has an average particle size being most the upper limit value of the above range or a BET specific surface area being at least the lower limit value of the above range, a formed product containing the fluororesin is excellent in stress crack resistance.

The average particle size is a value measured by a laser diffraction type particle size distribution measuring apparatus.

The BET specific surface area is a value measured by a nitrogen gas adsorption BET method.

The film is produced by forming the fluororesin B.

The film is suitably used as a release film for a sealing material in e.g. a semiconductor device or a light emitting diode. The release film is used for preventing adhesion of a heat press board to a printed wiring substrate, a flexible printed substrate or a multilayer printed wiring board, at the time of producing the printed wiring substrate, the flexible printed substrate or the multilayer printed wiring board by heat pressing a copper clad laminate plate or a copper foil on a substrate via a prepreg or a heat resistant film. Further, it is used for preventing adhesion of a heat press board to a cover ray film or adhesion of cover ray films to each other, at the time of producing a flexible printed substrate by letting the cover ray film adhere to a substrate having a copper circuit formed, by heat pressing, via a heat-curable adhesive.

As another use of the release film, a release film for producing a cast film or a release film for producing an IC chip may, for example, be mentioned.

As a use other than the release film, a solar cell protective film, a carrier film, an electronic substrate interlayer dielectric film, a laminated steel plate film, a package film, an agricultural greenhouse film, a food packaging film, a diaphragm for a diaphragm pump, a packing or a belt conveyer may, for example, be mentioned.

The electric wire is produced by extruding the fluororesin B around a core wire to form a coating layer.

The electric wire is suitably used for an electric wire for a small-size or large-capacity electronic equipment, a medical electric wire, an aircraft electric wire, a high voltage electric wire, an overhead electric wire, a high-frequency band communication electric wire, an electric heater electric wire, or an electric wire for an optical type sensor or an electrode type sense, which is required to have low elution property and low out gas property under high-temperature use.

Other formed products may, for example, be an electronic component, an aircraft component or a vehicle component. Further, a tube, a hose, a tank or a seal may, for example, be mentioned. As a specific use, one described in the paragraph [0059] of JP-A-2016-049764 may be mentioned.

In the above-described process for producing a fluororesin of the present invention, the relation of the melt volume-flow rate before and after the melt-kneading treatment satisfies the above formula (I), and therefore the effect of reducing a low-boiling component contained in the fluororesin is high. Further, the vacuum degree in a vent port of a vacuum vent is at most −0.07 MPa [gage], and therefore the effect of volatilizing a low-boiling component is excellent. Accordingly, a set temperature of the first melting zone can be kept within a relatively low range, specifically the melting point of the fluororesin +25 to 100° C., and therefore it is possible to suppress decomposition of the fluororesin, whereby it is possible to suppress increase of the low-boiling component due to the decomposition of the fluororesin. Accordingly, it is possible to sufficiently reduce the low-boiling component contained in the fluororesin.

Further, in the above-described process for producing a fluororesin of the present invention, it is not necessary to introduce a deaeration auxiliary agent (such as an inert gas (air, nitrogen, argon, helium or carbon dioxide) or water) into a twin screw extruder since the effect of reducing the low-boiling component contained in the fluororesin is high.

### EXAMPLES

Now, the present invention will be described in detail with reference to Examples, but the present invention is not limited thereto.

Ex. 1 to 6 are Examples of the present invention, and Ex. 7 to 11 are Comparative Examples.

### (Proportion of Units)

The proportion of each unit in the fluororesin was calculated from data measured by melt NMR analysis, fluorine content analysis and infrared absorption spectrum analysis.

### (Melting Point of Fluororesin)

Using a differential scanning calorimetry (DSC7020, manufactured by Seiko Instruments Inc.), the melting peak at the time of heating a fluororesin at a rate of 10° C./min was recorded, and the temperature (° C.) corresponding to the maximum value of the melting peak of the fluororesin was taken as the melting point.

### (Melt Volume-Flow Rate of Fluororesin)

Using a melt flow tester manufactured by Techno Seven Co., Ltd., an extrusion speed (g/10 min) at the time of extruding a fluororesin into an orifice with a diameter of 2.1 mm and a length of 8 mm under conditions at a temperature of 297° C. under a load of 49N was determined, and this extrusion speed was taken as the melt volume-flow rate.

### (Decomposition Temperature of Residue)

In a pressure resistant container, 30.0 g of a fluororesin and 300.0 g of 1,3-dichloro-1,1,2,2,3-pentafluoropropane were charged, and heated at 150° C. for 12 hours in a circulated hot air oven. After cooling to a room temperature, the resulting content was passed through a filter, and a filtrate was put in an eggplant flask. The filtrate was dried under reduced pressure at 50° C. by an evaporator to obtain a residue. A fluororesin which dissolves in 1,3-dichloro-1,1,2,2,3-pentafluoropropane has a molecular weight of approximately at most 100,000. The molecular weight is confirmed by a gel permeation chromatography (GPC).

The residue was subjected to a thermogravimetric (TG) measurement using a thermogravimetric/differential thermal device (TG/DTA7200, manufactured by Seiko Instruments Inc.), and from a TG curve, a temperature at which 1 mass % of the residue decomposes, a temperature at which 5 mass % of the residue decomposes, and a temperature at which 10 mass % of the residue decomposes, were determined.

### (Production of Fluororesin (A-1))

A polymerization reactor equipped with a stirrer, having an internal volume of 430 L, was deaerated. In the polymerization reactor, 418.2 kg of CF₃ (CF₂)₅ H, 2.12 kg of PFBE and 3.4 kg of methanol were charged, and a temperature in the polymerization reactor was increased to 66° C. with stirring. In the polymerization reactor, a mixed gas of TFE/ethylene=84/16 (molar ratio) was injected until the pressure in the polymerization reactor reached 1.5 MPa [gage]. In the polymerization reactor, a solution having 26 g of a 50 mass % CF₃ (CF₂)₅ H solution of tert-butyl peroxypivalate and 4,974 g of CF₃(CF₂)₅ H mixed was charged to initiate polymerization. During the polymerization, a mixed gas of TFE/ethylene=54/46 (molar ratio) and PFBE in an amount corresponding to 1.4 mol % relative to 100 mol % of the mixed gas, were continuously charged so that the pressure in the polymerization reactor would be 1.5 MPa [gage]. After 34 kg of the TFE/ethylene mixed gas was charged, the polymerization reactor was cooled, and a remaining gas was purged to terminate the polymerization.

The resulting slurry in the polymerization reactor was put into a 850 L granulation tank, and 340 L of water was charged, followed by heating with stirring, whereby a solvent and an unreacted monomer were removed to obtain granules. The granules were dried at 150° C. for 5 hours to obtain 34 kg of a fluororesin (A-1).

In a polymer contained in the fluororesin (A-1), the molar ratio ((a1)/(a2)) of the units (a1) based on ethylene to the units (a2) based on TFE, was 45.0/55.0 (molar ratio), and the proportion of the units (a3) was 1.7 mol %, relative to all units of the polymer constituting the fluororesin.

The melting point of the fluororesin (A-1) was 261° C.

The melt volume-flow rate of the fluororesin (A-1) was 6.8 g/10 min.

### (Production of Fluororesin (A-2))

34 kg of a fluororesin (A-2) was obtained in the same manner as the fluororesin (A-1) except that the molar ratio of TFE/ethylene was changed.

In a polymer contained in the fluororesin (A-2), the molar ratio ((a1)/(a2)) of the units (a1) based on ethylene and the units (a2) based on TFE was 45.5/54.5 (molar ratio), and the proportion of the units (a3) was 1.7 mol %, relative to all units of the polymer constituting the fluororesin.

The melting point of the fluororesin (A-2) was 261° C.

The melt volume-flow rate of the fluororesin (A-2) was 4.6 g/10 min.

### (Twin Screw Extruder)

As a twin screw extruder, a completely intermeshing type co-rotating twin screw extruder (KZW32TW, manufactured by TECHNOVEL CORPORATION) was prepared.

L/D of a total length L of a screw element and an inner diameter D of a barrel: 45

Inner diameter D of a barrel: 32 mm

Minimum chip clearance h in kneading element: 0.267 mm

Number of barrel blocks: 8

Vacuum vent (vacuum deaeration device): Water shield-vacuum pump (SW-25AS, manufactured by Shinko Seiki Co., Ltd., maximum pumping speed: 450 L/min)

Strand die head: STD321 (bore diameter of discharge port in die: 4 mm, number of discharge ports: 4) manufactured by TECHNOVEL CORPORATION.

### (Palletization)

As a cooling water tank, SCB250-2000 (width: 250 mm×depth: 250 mm×length: 2,000 mm) manufactured by TECHNOVEL CORPORATION, was prepared.

As a pelletizer, SCP-302 (diameter of rolling blade: 100 mm, length of rolling blade in center axis direction: 100 mm, number of blades of rolling blade: 10) manufactured by TECHNOVEL CORPORATION was prepared.

### Ex. 1

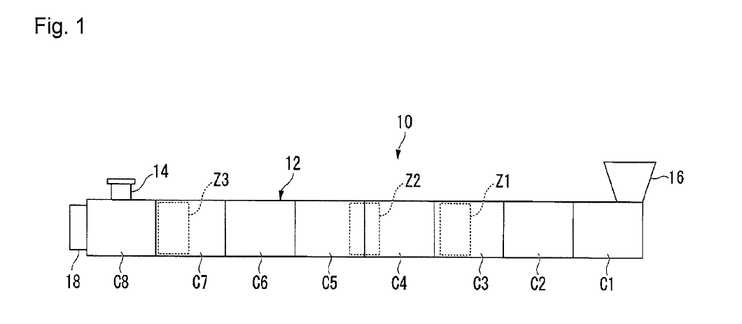

FIG. 1 is a schematic construction view illustrating a twin screw extruder used in Ex. 1.

A twin screw extruder 10 is provided with two screws (not shown), a barrel 12 having the two screws incorporated therein, a vacuum vent 14 disposed on the barrel 12, a raw material supply port 16 disposed on the barrel 12, and a strand die head 18 provided on the downstream end of the barrel 12.

The barrel 12 is provided with a first barrel block C1, a second barrel block C2, a third barrel block C3, a fourth barrel block C4, a fifth barrel block C5, a sixth barrel block C6, a seventh barrel block C7 and an eighth barrel block C8 in this order, from the upper stream.

The vacuum vent 14 is disposed on the eighth barrel block C8.

The raw material supply port 16 is disposed on the first barrel block C1.

The twin screw extruder 10 has a first melting zone Z1 at a part of the third barrel block C3, a second melting zone Z2 from a part of the fourth barrel block C4 to a part of the fifth barrel block C5, and a third melting zone Z3 at a part of the seventh barrel block C7. The screw elements other than the melting zones are all rotary elements. The number of screw elements (a total of the mixing elements and the kneading elements) in each melting zone and a total L/D in the melting zones are shown in Table 1.

The fluororesin (A-1) was charged from the raw material supply port 16 in the twin screw extruder 10, and the fluororesin (A-1) was melt-kneaded in the twin screw extruder 10. Melt-kneading conditions (a set temperature of each of the barrel blocks C1 to C8, a set temperature of a head, a set temperature of a dye, a vacuum degree in a vent port of the vacuum vent, a discharge amount Q of the fluororesin from the twin screw extruder, number N of revolutions of the screw, Q/(N×D³), a shear rate γ) are shown in Table 1.

A fluororesin B containing a low-boiling component lower than the fluororesin (A-1), obtained by melt-kneading the fluororesin (A-1) by the twin screw extruder 10 was extruded from the strand die head 18 to obtain a strand. The strand was subjected to water cooling by a cooling water tank, and then cut by a pelletizer to obtain pellets. A drawing speed was adjusted to be within a range of from 10 to 20 m/m in. The melt volume-flow rate α1 of the fluororesin A and the melt volume-flow rate α2 of the fluororesin B, α2−α1 and a decomposition temperature of a residue, are shown in Table 1.

### Ex. 2 to Ex. 11

Pellets of Ex. 2 to Ex. 11 were obtained in the same manner as in Ex. 1 except that, in the twin screw extruder, the number of melting zones, the position of each melting zone, the number of screw elements (a total of mixing elements and kneading elements) in each melting zone, a total L/D of the melting zones were changed as shown in Table 1 or Table 2, the melt-kneading conditions were changed as shown in Table 1 or Table 2, and a type of the fluororesin A to be used was changed as shown in Table 1 or Table 2. The results are shown in Table 1 and Table 2.

TABLE 1

| | | | Ex. 1 | Ex. 2 | Ex. 3 | Ex. 4 | Ex. 5 | Ex. 6 |
|---|---|---|---|---|---|---|---|---|
| Twin screw | Number of melting zones | | 3 | 1 | 3 | 3 | 3 | 2 |
| extruder | First melting zone | Position (barrel block) | C3 | C7 | C3 | C3 | C3 | C5-C6 |
| | | Number of screw elements | 3 | 3 | 3 | 3 | 3 | 3 |
| | Second melting zone | Position (barrel block) | C4-C5 | — | C4-C5 | C4-C5 | C4-C5 | C7-C8 |
| | | Number of screw elements | 4 | — | 4 | 4 | 4 | 4 |
| | Third melting zone | Position (barrel block) | C7 | — | C7 | C7 | C7 | — |
| | | Number of screw elements | 5 | — | 5 | 5 | 5 | — |
| | Vacuum vent | Number | 1 | 1 | 1 | 1 | 1 | 2 |
| | | Position (barrel block) | C8 | C8 | C8 | C8 | C8 | C6, C8 |
| | Total L/D of melting zones | | 10 | 2.8 | 10 | 10 | 10 | 6 |
| Melt- | Set temperature [° C.] | C1 | 290 | 275 | 290 | 290 | 290 | 290 |
| kneading | | C2 | 290 | 275 | 290 | 290 | 290 | 290 |
| conditions | | C3 | 290 | 275 | 290 | 290 | 290 | 290 |
| | | C4 | 320 | 335 | 320 | 340 | 300 | 335 |
| | | C5 | 320 | 335 | 320 | 340 | 300 | 315 |
| | | C6 | 320 | 335 | 320 | 340 | 300 | 335 |
| | | C7 | 290 | 335 | 290 | 290 | 290 | 320 |
| | | C8 | 320 | 335 | 320 | 320 | 300 | 320 |
| | | Head | 320 | 295 | 320 | 320 | 300 | 320 |
| | | Die | 320 | 295 | 320 | 320 | 300 | 320 |
| | Vacuum degree of vacuum vent [MPa [gaga]] | | −0.099 | −0.099 | −0.099 | −0.099 | −0.082 | −0.099 |
| | Discharge amount Q of fluororesin B [kg/h] | | 30 | 30 | 30 | 30 | 30 | 30 |
| | Number of revolutions of screw [rpm] | | 300 | 300 | 400 | 300 | 300 | 250 |
| | Q/(N × D³) [kg/mm³] | | 5.1 × 10⁸ | 5.1 × 10⁸ | 3.8 × 10⁸ | 5.1 × 10⁸ | 5.1 × 10⁸ | 4.1 × 10⁸ |
| | Shear rate γ [sec⁻¹] | | 1850 | 1850 | 2467 | 1850 | 1850 | 1542 |
| Result | Type of fluororesin A | | (A-1) | (A-1) | (A-1) | (A-1) | (A-1) | (A-2) |
| | Melting point of fluororesin [° C.] | | 261 | 261 | 261 | 261 | 261 | 261 |
| | Set temperature of first melting zone [° C.] | | 290 | 335 | 290 | 290 | 290 | 315 |
| | Melt volume-flow rate | α1 of fluororesin A | 6.8 | 6.8 | 6.8 | 6.8 | 6.8 | 4.6 |
| | [g/10 min] | α2 of fluororesin B | 9.6 | 8.7 | 13.3 | 9.8 | 8.1 | 9.5 |
| | | α2 − α1 | 2.9 | 2.0 | 6.5 | 3.0 | 1.3 | 4.9 |
| | Decomposition | 1 mass % | 120 | 119 | 125 | 116 | 116 | 120 |
| | temperature of | 5 mass % | 161 | 151 | 170 | 168 | 151 | 154 |
| | residue [° C.] | 10 mass % | 192 | 189 | 199 | 188 | 184 | 192 |

TABLE 2

| | | | Ex. 7 | Ex. 8 | Ex. 9 | Ex. 10 | Ex. 11 |
|---|---|---|---|---|---|---|---|
| Twin screw | Number of melting zones | | 2 | 2 | 2 | 0 | 1 |
| extruder | First melting zone | Position (barrel block) | C5-C6 | C5-C6 | C5-C6 | — | C7 |
| | | Number of screw elements | 3 | 3 | 3 | — | 3 |
| | Second melting zone | Position (barrel block) | C7-C8 | C7-C8 | C7-C8 | — | — |
| | | Number of screw elements | 4 | 4 | 4 | — | — |
| | Third melting zone | Position (barrel block) | — | — | — | — | — |
| | | Number of screw elements | — | — | — | — | — |
| | Vacuum vent | Number | Nil | 2 | 2 | 1 | 1 |
| | | Position (barrel block) | — | C6, C8 | C6, C8 | C8 | C8 |
| | Total L/D of melting zones | | 6 | 6 | 6 | 0 | 2.8 |
| Melt- | Set temperature [° C.] | C1 | 290 | 290 | 290 | 275 | 275 |
| kneading | | C2 | 290 | 290 | 290 | 275 | 275 |
| conditions | | C3 | 290 | 290 | 290 | 275 | 275 |
| | | C4 | 335 | 340 | 335 | 335 | 275 |
| | | C5 | 315 | 350 | 315 | 335 | 275 |
| | | C6 | 335 | 350 | 335 | 335 | 275 |
| | | C7 | 320 | 350 | 320 | 335 | 275 |
| | | C8 | 320 | 350 | 320 | 335 | 275 |
| | | Head | 320 | 350 | 320 | 195 | 195 |
| | | Die | 320 | 350 | 320 | 195 | 195 |
| | Vacuum degree of vacuum vent [MPa [gaga]] | | — | −0.096 | −0.04 | −0.09 | −0.099 |
| | Discharge amount Q of fluororesin B [kg/h] | | 20 | 20 | 20 | 30 | 30 |
| | Number of revolutions of screw [rpm] | | 250 | 350 | 250 | 300 | 300 |
| | Q/(N × D³) [kg/mm³] | | 4.1 × 10⁸ | 2.9 × 10⁸ | 4.1 × 10⁸ | 5.1 × 10⁸ | 5.1 × 10⁸ |
| | Shear rate γ [sec⁻¹] | | 1542 | 2159 | 1542 | 1850 | 1850 |
| Result | Type of fluororesin A | | (A-2) | (A-2) | (A-2) | (A-1) | (A-1) |
| | Melting point of fluororesin [° C.] | | 261 | 261 | 261 | 261 | 261 |
| | Set temperature of first melting zone [° C.] | | 315 | 350 | 315 | — | 275 |
| | Melt volume-flow rate | α1 of fluororesin A | 4.6 | 4.6 | 4.6 | — | 6.8 |
| | [g/10 min] | α2 of fluororesin B | 4.3 | 18.8 | 6.6 | — | 7.9 |
| | | α2 − α1 | −0.3 | 14.2 | 2.0 | — | 1.1 |
| | Decomposition | 1 mass % | 111 | 109 | 114 | — | 105 |
| | temperature of | 5 mass % | 144 | 140 | 151 | — | 147 |
| | residue [° C.] | 10 mass % | 180 | 168 | 181 | — | 180 |

In Ex. 7, the twin screw extruder has no vacuum vent, and therefore it was impossible to sufficiently remove a low-boiling component. Therefore, the decomposition temperature of the residue was low. That is, it was impossible to sufficiently reduce a low-boiling component of the fluororesin B.

In Ex. 8, α2−α1 exceeded 14, and therefore cleavage of the molecular chain of the fluororesin proceeded. Accordingly, the decomposition temperature of the residue was low. That is, it was impossible to sufficiently reduce a low-boiling component of the fluororesin B.

In Ex. 9, the vacuum degree in the vent port of the vacuum vent was more than −0.07 MPa [gage], and therefore it was impossible to sufficiently remove a low-boiling component. Therefore, the decomposition temperature of the residue was low. That is, it was impossible to sufficiently reduce a low-boiling component of the fluororesin B.

In Ex. 10, the twin screw extruder has no melting zones, and therefore vent-up occurred, whereby it was impossible to obtain the fluororesin B.

In Ex. 11, the set temperature of the first melting zone was less than the temperature of a melting point of the fluororesin +25° C., and therefore melting of the fluororesin A fails to accelerate, whereby decomposition more than needed occurred due to cleavage of a molecular weight of the fluororesin by the screw. That is, it was impossible to sufficiently reduce a low-boiling component of the fluororesin B.

### INDUSTRIAL APPLICABILITY

A fluororesin obtained by the production process of the present invention is useful as a film for film structures, a release film or a coating layer of an electric wire.

### REFERENCE SYMBOLS

10 twin screw extruder, 12 barrel, 14 vacuum vent, 16 raw material supply port, 18 strand die head, C1 first barrel block, C2 second barrel block, C3 third barrel block, C4 fourth barrel block, C5 fifth barrel block, C6 sixth barrel block, C7 seventh barrel block, C8 eighth barrel block, Z1 first melting zone, Z2 second melting zone, Z3 third melting zone

What is claimed is:

1. A process for producing a fluororesin, the process comprising:
subjecting a melt-formable fluororesin to melt-kneading treatment by the following twin screw extruder under the following conditions to produce a fluororesin satisfying the following formula (I):
α1<α2≤α1+14 (I)
wherein α2 is a melt mass-flow rate (g/10 min) of the fluororesin after the treatment, and α1 is a melt mass-flow rate (g/10 min) of the fluororesin before the treatment (provided that the two melt mass-flow rates are measured under a load of 49 N at the same temperature higher by 20 to 40° C. than the melting point of the fluororesin),
twin screw extruder: a twin screw extruder comprising two screws each having a shaft and a plurality of screw elements mounted on the shaft, a barrel having the two screws incorporated therein, and a vacuum vent disposed on the barrel, and comprising at least one melting zone in which, among the screw elements, two or more of mixing elements are continuously disposed, and/or two or more of kneading elements are continuously disposed,
melt-kneading conditions: a temperature of the most upstream melting zone among melting zones in the twin screw extruder is higher by 25 to 100° C. than the melting point of the fluororesin to be treated, and a vacuum degree at a vent port of the vacuum vent in the twin screw extruder is at most −0.07 MPa [gage].

2. The process according to claim 1, wherein in the twin screw extruder, the number of melting zones is from 1 to 6, the vacuum vent is located downstream of the most upstream melting zone, and a total length L (mm) of the screw elements in the melting zone and an inner diameter D (mm) of the barrel satisfy the following formula (II):
L/D≥3 (II)

3. The process according to claim 1, wherein in the twin screw extruder, a shear rate γ obtained from the following formula (IV) is at least 1,000 sec⁻¹,
γ=π×(D−2h)×N/(60×h) (IV)
wherein γ is a shear rate (sec⁻¹), π is 3.14, D is an inner diameter (mm) of the barrel, N is a number of revolutions (rpm) of the screw, and h is a minimum chip clearance (mm) in the kneading element.

4. The process according to claim 1, wherein the melt-kneading treatment is conducted to satisfy the following formula (III):
Q/(N×D³)<6.1×10⁻⁸ (III)
wherein Q is a discharge amount (kg/min) of the fluororesin from the twin screw extruder, N is a number of revolutions (rpm) of the screw, and D is an inner diameter (mm) of the barrel.

5. The process according to claim 1, wherein the fluororesin to be subjected to the melt-kneading treatment is a fluororesin not being subjected to treatment including melting during a period between production of the fluororesin by polymerization of monomers and the melt-kneading treatment.

6. The process according to claim 1, wherein the fluororesin is extruded into a strand from the twin screw extruder, and cut into a pelletized fluororesin subjected to the melt-kneading treatment.

7. The process according to claim 1, wherein the fluororesin comprises a copolymer having units based on ethylene and units based on tetrafluoroethylene.

8. The process according to claim 7, wherein the copolymer is a copolymer in which a proportion of the units based on ethylene is from 44 to 50 mol %, relative to the total of the units based on ethylene and the units based on tetrafluoroethylene.

9. The process according to claim 7, wherein the copolymer further comprises units based on a third monomer (provided that the third monomer may be composed of two or more types of monomers) copolymerizable with ethylene and tetrafluoroethylene, and a proportion of the units based on the third monomer is from 0.7 to 2.4 mol %, relative to all units of the copolymer.

10. The process according to claim 7, wherein the temperature in each of the measurements of the melt mass-flow rate α1 and the melt mass-flow rate α2 is 297° C.

11. The process according to claim 1, wherein the fluororesin subjected to the melt-kneading treatment contains the following residue,
a temperature at which 1 mass % of the following residue decomposes, is at least 115° C.,
a temperature at which 5 mass % of the following residue decomposes, is at least 150° C., and
a temperature at which 10 mass % of the following residue decomposes, is at least 180° C.:
residue: a residue obtained by immersing the fluororesin subjected to melt-kneading treatment in 1,3-dichloro-1,1,2,2,3-pentafluoropropane at 150° C. for 12 hours, then removing a solid matter, and heating a liquid under reduced pressure.

12. The process according to claim 1, wherein no deaeration auxiliary agent is introduced to the twin screw extruder when the fluororesin is subjected to the melt-kneading treatment by the twin screw extruder.

13. A process for producing a film, the process comprising:
obtaining a fluororesin by the process for producing a fluororesin as defined in claim 1; and
forming the fluororesin.

14. A process for producing an electric wire, said process comprising:
obtaining a fluororesin by the process for producing a fluororesin as defined in claim 1; and
extruding the fluororesin around a core wire to form a coating layer.

15. A fluororesin which is a melt-formable fluororesin, wherein
a temperature at which 1 mass % of the following residue decomposes, is at least 115° C.,
a temperature at which 5 mass % of the following residue decomposes, is at least 150° C., and
a temperature at which 10 mass % of the following residue decomposes, is at least 180° C.:
residue: a residue obtained by immersing the fluororesin in 1,3-dichloro-1,1,2,2,3-pentafluoropropane at 150° C. for 12 hours, then removing a solid matter, and heating a liquid under reduced pressure.
